(19) United States
(12) Patent Application Publication
(10) Pub. No.: US 2006/0221902 A1
(43) Pub. Date: Oct. 5, 2006

(54) Method for changing frequency channels of wireless electronic medical apparatus

(75) Inventors: Sue-Fen Chen, Taipei (TW); Shao-Hung Lee, Taipei (TW)

Correspondence Address: BACON & THOMAS, PLLC, 625 SLATERS LANE, FOURTH FLOOR, ALEXANDRIA, VA, 22314, US

(73) Assignee: HEALTH & LIFE CO., LTD, CHUNG HO CITY (TW)

(21) Appl. No.: 11/098,459

(22) Filed: Apr. 5, 2005

(51) Int. Cl. H04Q 7/00; H04Q 7/20

(52) U.S. Cl. 370/331; 455/436

(57) ABSTRACT

The present invention describes a method for changing frequency channels of a wireless electronic medical apparatus, which transmits or receives physiological signals produced by human bodies by means of a transmitter and its corresponding receiver of the wireless electronic medical apparatus, and such method includes a step of issuing an instruction to a channel switching module for switching a channel, if there is a conflict of using a frequency channel while several medical apparatuses are using the same frequency channel at the same time.

### BACKGROUND OF THE INVENTION

1. Field of the Invention

The present invention relates to a method for changing frequency channels of wireless electronic medical apparatus, which is used for transmitting and receiving physiological information of human bodies and changing the frequency channel of the wireless electronic medical apparatus.

2. Description of the Related Art

Before electronic stethoscopes were introduced, a traditional stethoscope adopted a long hollow tube to transmit biological sounds to the ears of a doctor, and such traditional stethoscope has the shortcomings of a distortion caused by resonances and a sound loss resulted from a long-distance transmission. Therefore, electronic stethoscopes were developed and related innovative technologies for amplifying signals greatly improve weak signals and transmission loss.

Wireless stethoscopes are further introduced, and a wireless stethoscope receives analog sounds produced by a patient's body through a contact type microphone. The analog signals are converted into digital signals that are sent by a transmitting circuit and received by a wireless receiver. The stethoscope for hearing physiological information of human organs is integrated with the wireless transmission technology to covert various analog sound signals produced by human organs into digital audio signals and then the digital signals are sent out. After digital signals are received by a corresponding receiver, sounds can be heard from an electronic earpiece or the stethoscope.

Referring to FIG. 5, the foregoing prior art wireless electronic stethoscope only provides digital data and discloses general wireless transmission functions, but the prior art wireless electronic stethoscope does not have a solution for the frequency channel interference problem of the wireless transmission. Particularly, if the wireless electronic stethoscope is applied in medical treatments in a clinic and medical professionals use different wireless electronic medical apparatuses (such as wireless electronic stethoscopes) for auscultations at the same time, and there is a conflict of frequency channels, the medical professionals may obtain wrong signals from other patient's heart sounds, lung sounds and related biological signals and result a wrong diagnosis.

Although a wireless network has mobility and convenience that traditional cable network cannot accomplish, the transmitting medium of the wireless network involves electromagnetic radiation in a particular form such as infrared and radio waves.

As to the present wireless transmission technology, three standard Industrial Scientific Medial (ISM) bands are opened for the long-distance wireless area network transmission and these frequency channels are 902˜928 MHz, 2.4˜2.483 GHz and 5.725˜5.875 GHz. Since communication products using the ISM bands become increasingly popular, therefore the IEEE802.11 wireless LAN standard is introduced.

According to the IEEE802.11 wireless LAN standard established by the Institute of Electrical and Electronic Engineers, various wireless LAN devices in compliance with this standard can use a 2.4 GHz band for transmitting wireless signals and achieving the purpose of exchanging information, and the 2.4 GHz band of the IEEE802.11 wireless LAN standard is a free band. Users need not to file an application to any organization for using the band. Furthermore, the wireless transmission rate of such standard has been updated from 2 Mbits per second to the present 11 Mbits per second, and the transmission will reach a much faster speed to support multimedia transmission through networking.

However, the IEEE802.11a operating band according to the IEEE802.11 specification falls between 5.18 GHz and 5.805 GHz, and both IEEE802.11b and IEEE802.11 are operated at the wireless frequency band between 2.402 GHz and 2.483 GHz (which is called the Industrial, Scientific and Medical, ISM, band). At present, only 11 channels are available for the wireless base stations in Taiwan. For example, only three independent channels (including Channels 1, 6 and 11) are provided for the IEEE802.11b wireless transmissions. In other words, a fourth wireless base station will be interfered by other wireless base stations which use any of the three available bands. For Bluetooth technology that provides a short-distance wireless LAN transmission standard, the Bluetooth standard stems from mobile phones. To provide convenient connections of mobile phones and peripherals, Ericcson, Nokia, IBM, Toshiba and Intel jointly defined and developed a wireless transmission specification.

The Bluetooth technology is similar to the Infrared Data Association (IrDA) wireless transmission technology, and both are designed for short-distance wireless transmissions, but an IrDA device requires aligning two transmission devices with each other for transmitting data. The infrared may be blocked by walls or other objects, and thus most of the present wireless LAN products use radio waves as media. The Bluetooth technology is a “point” transmission technology, of which data is transmitted out in a radial and spherical form from a transmitting point for the signal transmissions.

Bluetooth technology provides a radial transmission, and thus several receiving ends can share a transmitting end in general networking applications, but Bluetooth is not applicable for medical detections while strictly no misjudgment is allowed. Therefore, there is no existing wireless transmission method for the wireless stethoscope or feasible solution for overcoming the mutual interference problem.

### SUMMARY OF THE INVENTION

In view of the foregoing problems, it is a primary objective of the present invention to provide a method of changing frequency channels of wireless electronic medical apparatus.

To achieve the foregoing objective, the present invention discloses a method of changing frequency channels of wireless electronic medical apparatus, which comprises a physiological measuring device having a chest piece of an electronic stethoscope or a pulse sensor of an electronic sphygmomanometer in contact with a patient's body, and the measuring device has a first transceiver with a microcontroller and a wireless transmitting circuit for sending out processed human organ information; a wireless receiving device having a second transceiver of the wireless receiving circuit for receiving the information transmitted from the first transceiver. The physiological signals of the human organ information such as heart sounds, lung sounds, or pulses are detected by the physiological measuring device, sent to the second transceiver of the wireless receiving circuit, and provided to medical professions for accurate diagnoses and follow-ups.

If the physiological measuring device and the wireless receiver come with factory default serial numbers and a plurality of default backup frequency channels, and different sets of physiological measuring devices are using the same frequency channel, then an instruction for changing frequency channels is issued, such that a channel switching module changes the frequency channel at the same time and uses another backup frequency channel for transmitting or receiving signals.

The above and other objects, features and advantages of the present invention will become apparent from the following detailed description taken with the accompanying drawings.

### BRIEF DESCRIPTION OF THE DRAWINGS

FIG. 1 is a flow chart of a method of changing frequency channels of wireless electronic medical apparatus in accordance with the present invention;

FIG. 2 is a schematic view of a wireless stethoscope applied in the present invention;

FIG. 3 is a schematic view of a wireless sphygmomanometer applied in the present invention;

FIG. 4 is a schematic view of a wireless stethoscope applied in a preferred embodiment of the present invention; and

FIG. 5 is a schematic view of a prior art device.

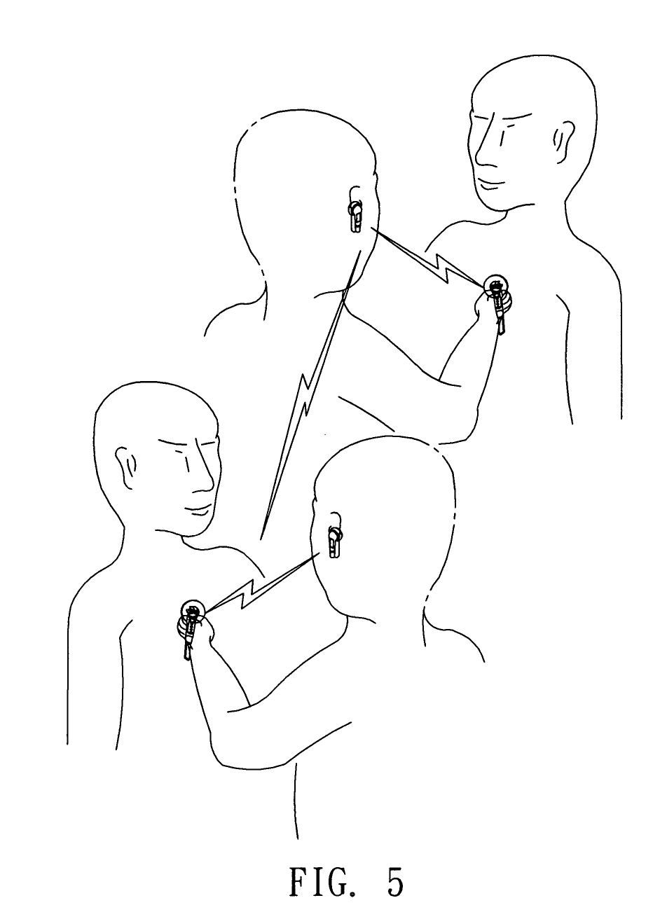

### DETAILED DESCRIPTION OF THE PREFERRED EMBODIMENTS

To make it easier for our examiner to understand the present invention, the following detailed description with reference to the accompanying drawings of an embodiment are given for example, but such preferred embodiment is not intended to limit the scope of the present invention.

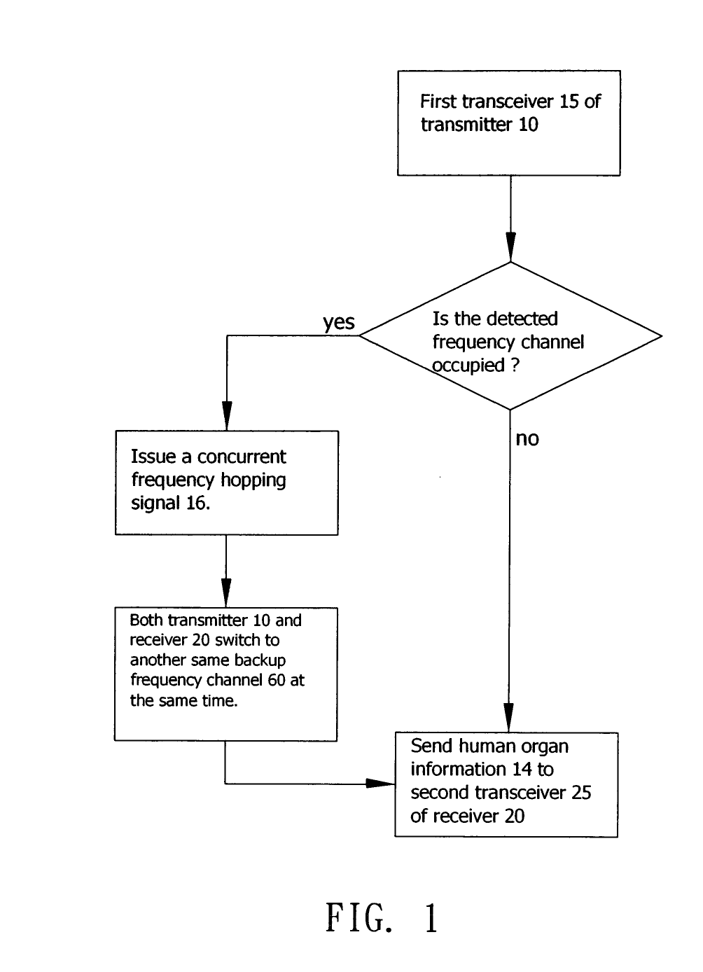

Referring to FIG. 1, a flow chart of a method of changing frequency channels of wireless electronic medical apparatus in accordance with the present invention is shown. If a transmitter 10 sends out human body information, a first transceiver 15 will detect whether or not different sets of wireless electronic medical apparatuses are concurrently using the same frequency channel and will check whether or not the serial numbers are the same. If there is no signal transmitted through the same frequency channel, then the human body information will be sent to a receiver 20 having the same serial number. If there are signals transmitted concurrently through the same frequency channel, then a first transceiver 15 of the transmitter will send out a concurrent frequency hopping signal 16 to a second transceiver 25 of the receiver 20 with the same serial number. Therefore, the transmitter 10 and the receiver 20 can simultaneously change their frequency channels to another backup frequency channel 60.

In other words, the present invention comprises at least a first transceiver and a second transceiver in a wireless electronic medical apparatus, and the first transceiver 15 on the transmitter 10 notices the second transceiver 25 on the receiver 20 having the same serial number to change to a backup frequency channel according to a method comprising the steps of:

(A) detecting a signal of the same frequency channel by the first transceiver 15 or the second transceiver 25; and

(B) sending out a concurrent frequency hopping signal 16 by the first transceiver 15 or the second transceiver 25 to notice the second transceiver 25 having the same serial number or the first transceiver 15 to switch to another backup frequency channel 60 simultaneously, so as to prevent transceivers of different serial numbers from receiving unintended signals from each other.

Further, a frequency channel switching module 25 installed on the receiver 20 and a frequency channel switching module 15 installed on the transmitter 10 according to the present invention can receive a press button signal transmitted from a remote control 500. The receiving frequency channel or the transmitting frequency channel is switched according to the press button signal to prevent any unintended transmission of human organ information between the physiological measuring device and the wireless receiver of different serial numbers.

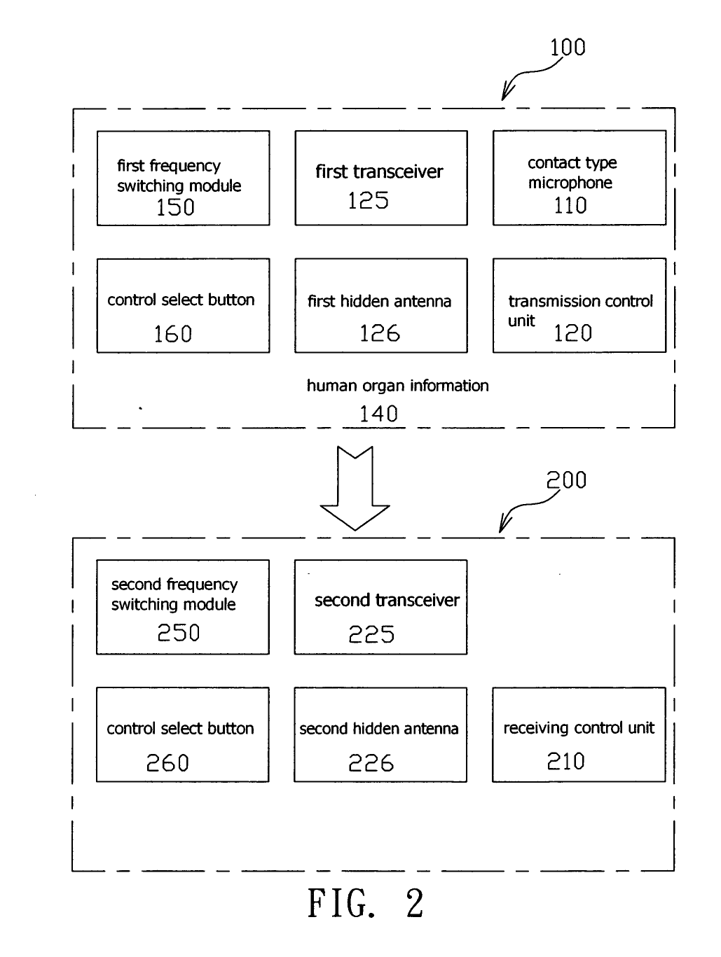

Referring to FIG. 2, a schematic view of a wireless electronic stethoscope applied in the present invention is shown. In FIG. 2, a stethoscope device 100 (which could be a chest piece of an electronic stethoscope) comprises a contact type microphone 110; a transmission control unit 120 having a power amplifier and a wireless transmit circuit; a first transceiver 125 and a first hidden antenna 126 for producing a filtered human organ information 140; a first frequency channel switching module 150 for automatically or using a select button 160 installed at the stethoscope device 100 to change the transmitting frequency channel; a wireless receiver 200 (which could be an earpiece of an electronic stethoscope or a computer); a receiving control unit 210 having a wireless receive circuit; a second transceiver 225 and a second hidden antenna 226 for receiving or displaying the human organ information 140; and a second frequency channel module 250 for automatically or using a select button 260 installed on the wireless receiver 200 to change the transmitting frequency channel. The foregoing frequency channel switching modules can transmit signals to the wireless receiver through a remote control 500 to change the frequency channel.

In an application, a user may use a contact type microphone 110 installed in the stethoscope device 100 to contact a patient's body, so that the sounds such as heart sounds, lung sounds, pulses, internal organ sounds produced in the patient's body are amplified to produce a human organ information 140, and such information 140 is sent out by the transmission control unit 120. The human organ information 140 is received by the wireless receiver 200 through the transmission control unit 120.

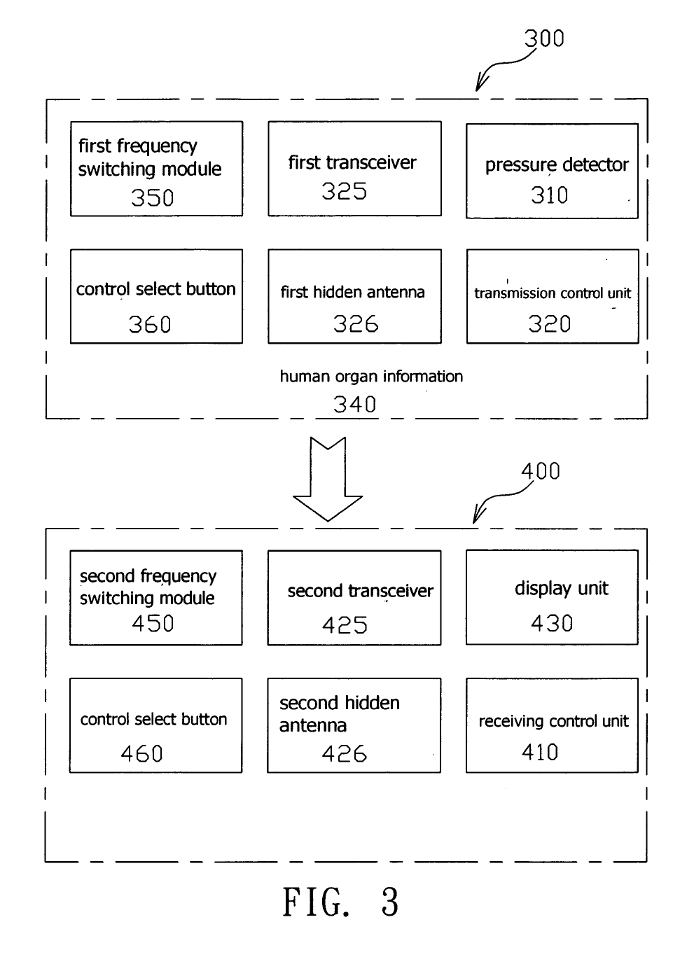

Referring to FIG. 3, a schematic view of a wireless electronic sphygmomanometer applied in the present invention is shown. The sphygmomanometer comprises a wireless electronic sphygmomanometer unit 300 having a pressure detector 310 and a transmission control unit 320, and the transmission control unit 320 has a wireless transmit circuit; a first transceiver 325 and a first hidden antenna 326 for producing a filtered human organ information 340 (such as a diastolic pressure, a systolic pressure, or a heartbeat); a first frequency channel switching module 350 for automatically or using a select button 360 installed at the sphygmomanometer unit 300 to change the transmitting frequency channel; a wireless receiver 400; a receiving control unit 410 having a wireless receive circuit; a first transceiver 425 and a first hidden antenna 426 for receiving or displaying an amplified human body information 340; and a display unit 430 for displaying the human body information 340.

In an application, a user may use a wireless electronic sphygmomanometer device 300 to contact a patient's body, so that the measured signals such as pulses or blood pressures are amplified and processed to produce a human body information 340, and such information 340 is sent out by the transmission control unit 320. The human body information 340 is received by the receiving control unit 410 of the wireless receiver 400 and the physiological signals are displayed on the display unit 430 (or the computer). A second frequency channel switching module 450 for automatically or using a select button 460 installed at the receiver 400 to change the transmitting frequency channel; a wireless receiver 400, and the foregoing frequency channel switching modules can send out signals to the receiver 400 through a remote control 500 to change its frequency channel.

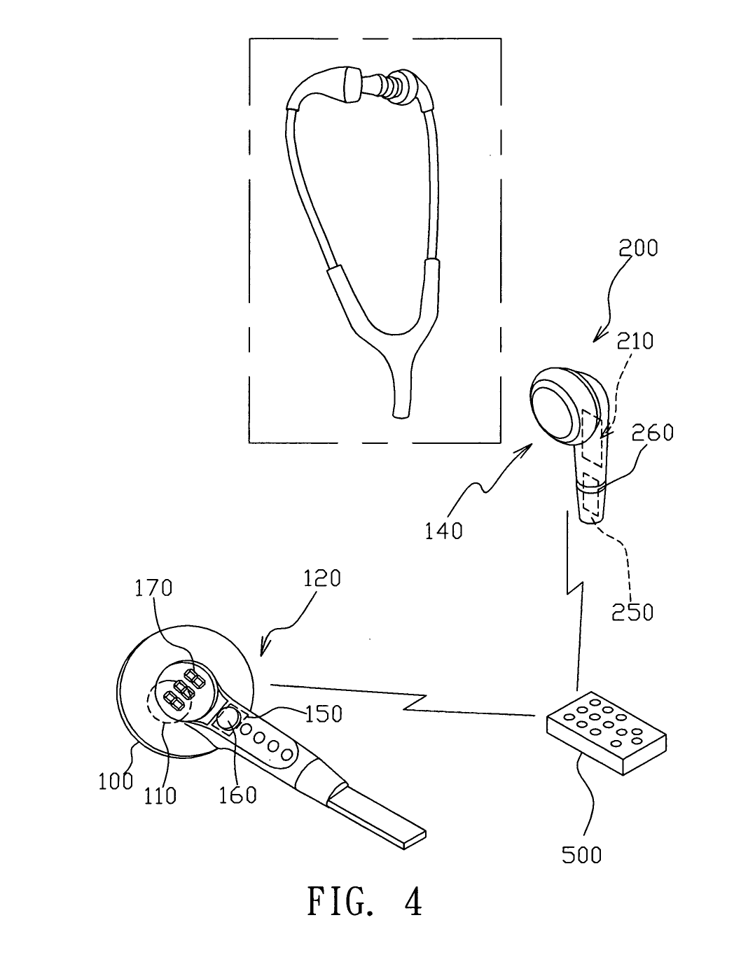

Referring to FIG. 4, a schematic view of a wireless stethoscope applied in a preferred embodiment of the present invention is shown. In the wireless stethoscope of this embodiment, the contact type microphone 110 of the stethoscope device 100 is in contact with a patient's body to receive sound signals such as heart sounds, lung sounds, internal organ sounds, and these signals are amplified and filtered to produce a human organ information 140 to be displayed on the display unit 170. Such information 140 is sent out by the transmission control unit 120. The human organ information 140 is received by the wireless receiver 200 (the electronic earpiece or computer) through the receiving control unit 210.

A first frequency channel switching module 150 installed on the stethoscope device 100 for automatically or using a select button 160 installed at the stethoscope device 100 to change the transmitting frequency channel, and the receiving control unit 210 also has a second frequency channel switching module 250 for automatically or using a select button 160 installed at the receiver 200 to change its transmitting frequency channel, or the foregoing first frequency channel switching module 150 and the second frequency channel switching module 250 can send out press key signals to the receiver through a remote control 500 to change its frequency channel.

The description and its accompanied drawings are used for describing preferred embodiments of the present invention, and it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

First transceiver 15 of transmitter 10

Is the detected frequency channel occupied? Yes/No

Issue a concurrent frequency hopping signal 16.

Both transmitter 10 and receiver 20 switch to another same backup frequency channel 60 at the same time.

Send human organ information 14 to second transceiver 25 of receiver 20

FIG. 1

150 first frequency switching module
125 first transceiver
110 contact type microphone
160 control select button
126 first hidden antenna
120 transmission control unit
250 second frequency switching module
225 second transceiver
260 control select button
226 second hidden antenna
210 receiving control unit
   FIG. 2
350 first frequency switching module
325 first transceiver
310 pressure detector
360 control select button
326 first hidden antenna
320 transmission control unit
450 second frequency switching module
425 second transceiver
430 display unit
460 control select button
426 second hidden antenna
410 receiving control unit
   FIG. 3

What is claimed is:

1. A method for changing frequency channels of wireless electronic medical apparatus, comprising the steps of:
using at least a first transceiver and a second transceiver in a wireless transmission system;
said first transceiver on a transmitter using a process of noticing said second transceiver on a wireless receiver having the same serial number to change its frequency channel, and said process comprising the steps of: (A) detecting a signal of the same frequency channel from said first or second transceiver; (B) transmitting a concurrent frequency hopping signal from said first or second transceiver, and noticing said second transceiver with the same serial number or said first transceiver to concurrently switch to another same backup frequency channel, so as to prevent said transceivers with different serial numbers from receiving unintended information with each other.

2. The method for changing frequency channels of wireless electronic medical apparatus of claim 1, wherein said transmitter is a chest piece of an electronic stethoscope.

3. The method for changing frequency channels of wireless electronic medical apparatus of claim 1, wherein said transmitter is a wireless electronic sphygmomanometer.

4. The method for changing frequency channels of wireless electronic medical apparatus of claim 1, wherein said receiver is an electronic earpiece.

5. The method for changing frequency channels of wireless electronic medical apparatus of claim 1, wherein said receiver is a computer.

6. The method for changing frequency channels of wireless electronic medical apparatus of claim 1, wherein said first or second transceiver is capable of receiving a press button signal from a remote control to change to another backup frequency channel for a signal transmission.
